(19) United States
(12) Patent Application Publication
(10) Pub. No.: US 2009/0125382 A1
(43) Pub. Date: May 14, 2009

(54) Quantifying a Data Source's Reputation

(75) Inventor: Rajiv Delepet, Santa Monica, CA (US)

Correspondence Address: FISH & ASSOCIATES, PC;ROBERT D. FISH, 2603 Main Street, Suite 1000, Irvine, CA, 92614-6232, US

(73) Assignee: WISE WINDOW INC., Santa Monica, CA (US)

(21) Appl. No.: 12/265,130

(22) Filed: Nov. 5, 2008

Related U.S. Application Data
(60) Provisional application No. 60/986,131, filed on Nov. 7, 2007.

(51) Int. Cl. G06N 5/02; G06Q 10/00

(52) U.S. Cl. 705/10; 706/46

(57) ABSTRACT

Methods of quantifying a reputation for a data source are presented. Historical documents having opinions and that are attributed to a data source are identified. The opinions preferably are quantifiable and can be converted into a predication. As the predications are verified, the data source is assigned one or more predication scores indicating the accuracy of the predications. A reputation score for a new document having a new predication can be assigned to the data source as a function of the predictions scores from the historical documents, data source affiliations, document topics, or other parameters. The reputation score relating to the new document can be presented to a user via a computer interface as a single-value, or multiple values corresponding to different topics.

This application claims the benefit of priority to U.S. Provisional Application having Ser. No. 60/986,131, filed on Nov. 7, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is technologies for providing an indication of a data source's accuracy with respect to past expressed opinions.

### BACKGROUND

Consumers often seek information relating to nearly any topic over the Internet. However, most of the information accessible to a consumer comes from unknown data sources. For example, a person might be interested in product reviews for a television as can be typically found on most retail web sites, Amazon™ for example. However, the person encounters multiple issues. One issue encountered by a person results from the sheer volume of reviews available, which can obscure relevant or interesting information relating to a topic. Another issue encountered by a person includes that the person has little or no means of knowing if a reviewer providing a review is a reputable source for the review. Yet another issue includes that the reviews can cover many topics, which further obscures how a reviewer's opinions relate to a topic of interest. Some Internet sites attempt to address the lack of reputation by allowing users to rate a review or article (e.g., Amazon or Digg.com). However, such ratings lack any indication if the source of the review or article is reputable, if the source has a solid track record across a broad range of topics and reviews, or how the reviewer's opinions relate to multiple topics in a review. These and other issues are not limited to consumers, but also apply to market researchers wishing to analyze a brand's buzz, trends, sentiment, or other marketing characteristics related to a brand.

Others have put forth tangential effort in providing a concrete, quantifiable measure of a data source's reputation, but have yet to address aggregating opinion data across a body of work. For example, U.S. Pat. No. 5,371,676 to Fan titled “Information Processing Analysis System for Sorting and Scoring Text” describes a system for predicating public opinion based on text messages. Fan discusses that various media including radio and television can be assigned a reputation score for reliability with respect to truthfulness. However, Fan fails to offer insight into how to quantify a reputation and fails to appreciate that a reputation can reflect the accuracy of expressed opinions when treated as a predication that can be verified at a later date.

U.S. Pat. No. 6,895,385 to Zacharia et al. titled “Method and System for ascribing a Reputation to an Entity as a Rater of other Entities” discusses determining a reputation based on how well a person's ratings correspond to ratings of others. However, Zacharia merely compares a single person's opinion against an average over opinions of others as opposed to establishing a track record a person's opinions aggregated over many documents and topics.

U.S. Patent Application Publication 2007/0078675 to Kaplan titled “Contributor Reputation-Based Message Boards and Forums” makes further progress toward quantifying reputation. Kaplan describes tracking contributor's predications with respect to stocks. The accuracy of the predications is tracked and presented within a message board. Unfortunately, Kaplan also fails to aggregate opinions across many documents and topics.

The above and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Consumers, market researchers, or other entities still require some means for determining if a source of information expressing an opinion is actually reputable with respect to a topic. What has yet to be appreciated is that an expressed opinion of a data source (e.g., a product reviewer, stock pundit, article author, etc.) with respect to one or more topics can be converted to a quantifiable predication. The predictions can be verified and used to quantify a reputation for the data source with respect to the topics. A data source's track record can be established by collecting documents originating from the data source where the documents have a quantifiable opinion with respect to a topic. The opinion can be treated as a form of “prediction” with respect to an expected outcome. For example, a movie reviewer's rating of a movie can be considered a prediction of how movie viewers in aggregate will rate the movie. The reputation of the source can be a measure of how accurate the source's opinions or predications correspond to verifiable outcomes.

Unless a contrary intent is apparent from the context, all ranges recited herein are inclusive of their endpoints, and open-ended ranges should be interpreted to include only commercially practical values.

Thus, there is still a need for quantifying the reputation of a data source.

### SUMMARY OF THE INVENTION

The inventive subject matter provides apparatus, systems and methods in which a data source's reputation can be quantified with respect to one or more topics. One aspect of the inventive subject matter includes a method of quantifying a reputation of a data source (e.g., a person, a company, a computer simulation, etc. . . . ). The method can include searching for web documents, possibly using a publicly accessible search engine to search the Internet, that discuss various topics of interest and that are considered to be associated with the data source. At least some of the web documents can be formed into a set of historical documents where the documents in the set satisfy the searching requirements and, preferably, have an opinion expressed by the data source. The opinions can be converted into quantifiable predications with respect to the topic. The historical documents can be analyzed to correlate the predictions against verifiable outcomes that could be found within other web documents. A prediction score can be assigned to the data source to indicate how well the predictions stemming from the opinions of the data source match actual outcomes. The predication score can be used to derive a reputation score for the data source with respect to a new document having a new opinion. In a preferred embodiment, a data source's reputation score relating to the new document is presented via a computer.

A data source's reputation score can also be adjusted based on many different circumstances. For example, a reputation score can be adjusted, possibly in a positive or negative manner, based on a data source's affiliation with one or more organizations. In some circumstances, the data source could be an employee of a reputable company. Additionally, the data source could be affiliated with two or more different organizations. A reputation score can also be adjusted based on topics. A data source's reputation score could be increased to reflect that the data source has a proven track record for a given topic or decreased to reflect that the topic is unfamiliar to the source. In some embodiments, the reputation score can be adjusted based on a difference between a first topic and a second topic where the difference can be represented by a calculated similarity measure, possibly based on a hierarchical classification of topics.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of an environment where a reputation can be quantified for a data source.

FIG. 2 is a schematic of an example with respect to movies.

FIG. 3 is a schematic of a method for quantifying a reputation of a data source.

### DETAILED DESCRIPTION

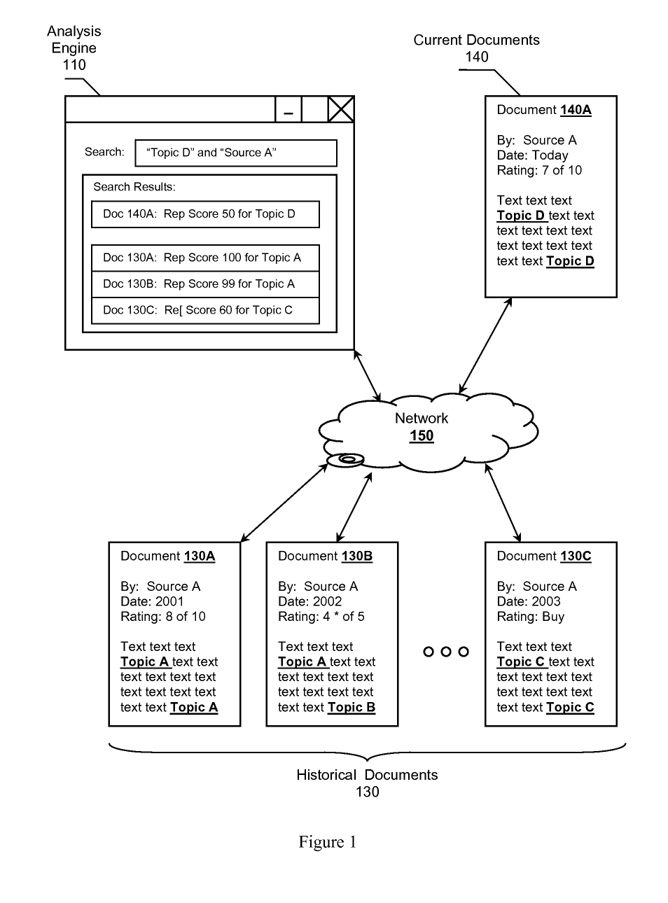

FIG. 1 provides an overview of an environment where an individual utilizes analysis engine 110 to obtain one or more web documents attributed to a data source. Each of the documents along with an associated reputation score can be presented to the individual via a computer interface.

In the example shown within FIG. 1, analysis engine 110 is illustrated as a search engine having a web browser interface. Examples of suitable search engines include those offered by Google™, Yahoo!™, or Microsoft™. However, engine 110 can comprise other types of computer systems including a dedicated analysis software application running on a computer, a web-based service offered over the Internet, or other computing platforms. One example of a suitable computer platform that can be used as analysis engine 110 includes the marketing analytics services offered by Wise Windows, Inc of Santa Monica, Calif. (httpe://www.wisewindows.com). Furthermore, the disclosed techniques can be integrated into various applications including search engines, office productivity applications, or other computing applications.

In a preferred embodiment, analysis engine 110 searches for web documents that relate to a specified topic and are attributed to a data source. Engine 110 identifies one or more of historical documents 130A, 130B, through 130B, collectively referred to as historical documents 130, from the web documents that satisfy searching criteria and that have an opinion expressed by the data source. Documents 130 preferably include web-accessible documents that can be accessed automatically over network 150, possibly by an automated bot. Documents 130 can include text data, image data, audio data, or other forms of digital data.

Documents 130 can be identified using various suitable means. In some embodiments, documents 130 can be found via a search engine by submitting one or more search terms corresponding to a topic of interest or to a data source. Search terms can correspond to a key word, an image, or even audio data. Engine 110 can search the Internet for web documents having the data or metadata corresponding to the specified search terms. The resulting set of web documents are preferably formed into a set of historical documents 130 that can then be used for analysis.

Preferred documents are attributed to source, relate to a specified topic, and include a quantified opinion. For example, document 130A represents a text-based document authored by “Source A” and includes a reference to “Topic A”. A topic can include nearly any item that can be represented via digital data. Preferred topics include those pertaining a brand, possibly a company, product, or person related to the brand. A data source can include individuals that produce documents. Especially preferred data sources include a person, a business, or even a computer model. Documents 130 can be directly attributed to a data source (e.g., authored by or produced by the data source) or can be indirectly attributed to a data source, possibly through an affiliation with an organization. For example, the data source could be an employee of a company that has produced one of documents 130.

A quantified opinion comprises a specified absolute or relative measure that preferably corresponds to a numerical value. Absolute measures represent a value on a scale, for example a rating on a scale of one to ten. Absolute measures preferably have a direct correspondence to a numerical value. Relative measures are more subjective in nature and indicate a value with respect to a current state. An example of relative measures includes a buy rating for a stock. Relative measures often require a mapping from a relative value to a numerical value. For example, one could map a buy rating of a stock to “+1”, a hold rating “0”, or a sell rating to “−1”.

The quantified opinion can be converted to a prediction that expresses an expected outcome with respect to a topic. For example, a movie rating from a reviewer can be considered a prediction of how movie viewers in aggregate or on average would rate a movie, or a buy/sell rating of a stock can be considered a prediction of the movement of a stock price. Preferred predications include a discernable time frame for which the predication applies, which provides for concrete verification in circumstances where a predication would otherwise be open-ended. With respect to movies, a time frame could include the release date of a movie. With respect to stocks, a time frame could include a statement on how long to hold a stock.

Engine 110 preferably utilizes documents 130 as a foundation for generating a reputation score of a data source with respect to one or more topics. The predications established from the opinions expressed by the source can be correlated against verifiable outcomes that possibly occur within the predications specified time frame. Each prediction having a verifiable outcome can be scored with an outcome score where each outcome score is optionally normalized on a common scale. The outcomes scores can be aggregated to arrive at a predication score which can then be assigned to the data source. The predication score can be considered an accuracy measure of the data source with respect to one or more topics.

A reputation score can be derived from the predication score generated from the historical documents 130 and can be applied to a current document 140 relating to a second, possibly different topic and having a new opinion that currently lacks a verifiable outcome. In simple embodiments, the reputation score is the same as the predication score, which itself can be the same as an outcome score. In more preferred embodiments, the reputation score can be adjusted based on the similarity of the topics within documents 130 and document 140, based on affiliations of the data source, or based on other parameters known to engine 110.

Analysis engine 110 preferably can identify current documents 140 relating to a topic in a similar manner as identifying historical documents 130. Engine 110 also preferably presents documents 140 along with the derived reputation score with respect to the topic.

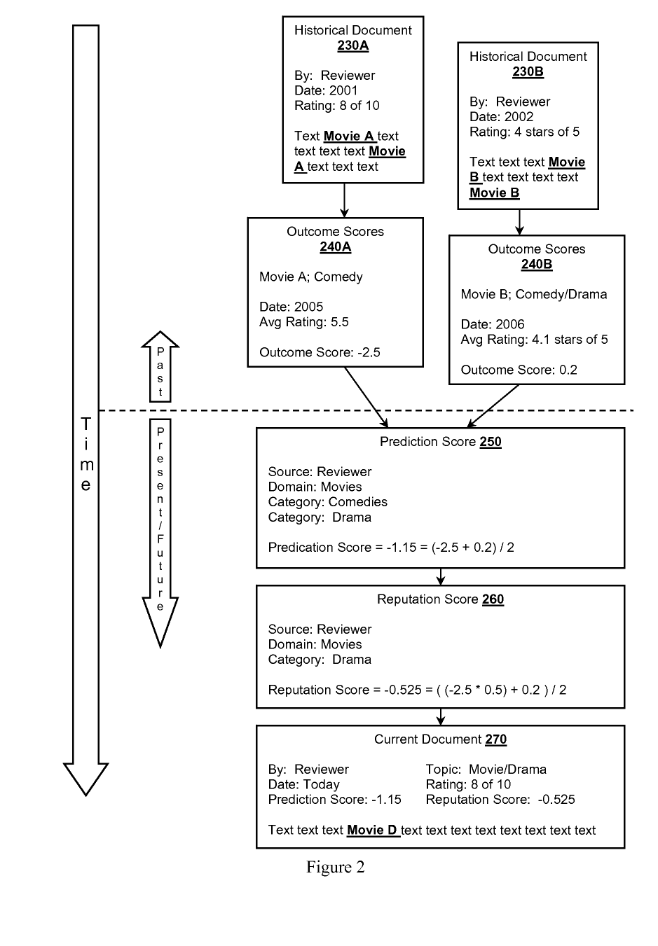

In FIG. 2, a more concrete example of quantifying a reputation is presented for clarity. The example is presented within the context of movie reviews and is presented as a time line. One should appreciated that the disclosed techniques can be equally applied to other areas beyond movie reviews including product reviews, stock quotes, medical diagnosis, or other areas where opinions can be converted to predications.

One or more of historical documents 230A and 230B, collectively referred to as historical documents 230, are identified as past movie reviews from a reviewer. Each document is attributed to the reviewer and includes an opinion that can be converted to a predication in the form of a rating for Movie A and a rating for Movie B. The predications are correlated with one or more of verifiable outcomes that can be used to generate outcome scores 240A and 240B, referred to as outcome scores 240. Outcomes scores 240 comprise values that can be compared with the predictions. Preferably, outcome scores 240 can be found in one or more web documents.

In the example shown outcomes scores 240 each comprise an average movie rating compiled from a plurality of movie viewers. Movie A has an average rating of 5.5 and Movie B has an average rating of 4.1 stars out of five stars.

An outcome score 240 can be derived for each of the predications stemming from the reviewer's opinions. The outcome scores 240 can be derived using any suitable algorithm or formula. For example, document 230A has a rating of 8 out of 10 for Movie A and the verifiable outcome indicated a rating of 5.5. An outcome score for the predication of document 230A could simply be the value of the verifiable outcome minus the predicated rating, −2.5 in this example. Similarly, an outcome score can be calculated for Movie B. In the case of Movie B, Movie B's outcome score is normalized with respect to the outcome score of Movie A. For example, outcome score 240B has been normalized to a ten point scale as opposed to a five point scale. On a five point scale the outcome score for Movie B's predication would be 0.1 (e.g., 4.1-4 on a scale of five star); however, on a ten point scale outcome 240B would be 0.2 as shown.

The outcomes scores 240 of the predications can be aggregated together to form prediction score 250. For example, the predication score 250 could be an average of all normalized outcome scores 240 as shown. In the movie review example shown in FIG. 2, predication score 250 is −1.15, which indicates that the reviewer tends to overrate movies. It should be noted that the derivation of prediction score 250 can be function of arbitrary complexity with respect to outcome scores 240.

Prediction score 250 can be used to calculate one or more of reputation score 260 for a reviewer with respect to a given topic, a drama movie for example. In a simple embodiment reputation score 260 is simply equal to prediction score 250. In a preferred embodiment, reputation score 260 can be adjusted, possibly by weighting outcome scores 240, based on the reviewers familiarity with a topic (e.g., drama movies). In the example shown, the weight of the reviewer's opinions with respect to comedies has been reduced because the current topic of interest is drama movies. The result is reputation score 260 is −0.525 representing that the reviewer only slightly over rates dramas.

In a preferred embodiment, when a reviewer provides access to current document 270 representing a review of a new drama movie, current document 270 is presented to readers along with reputation score 260.

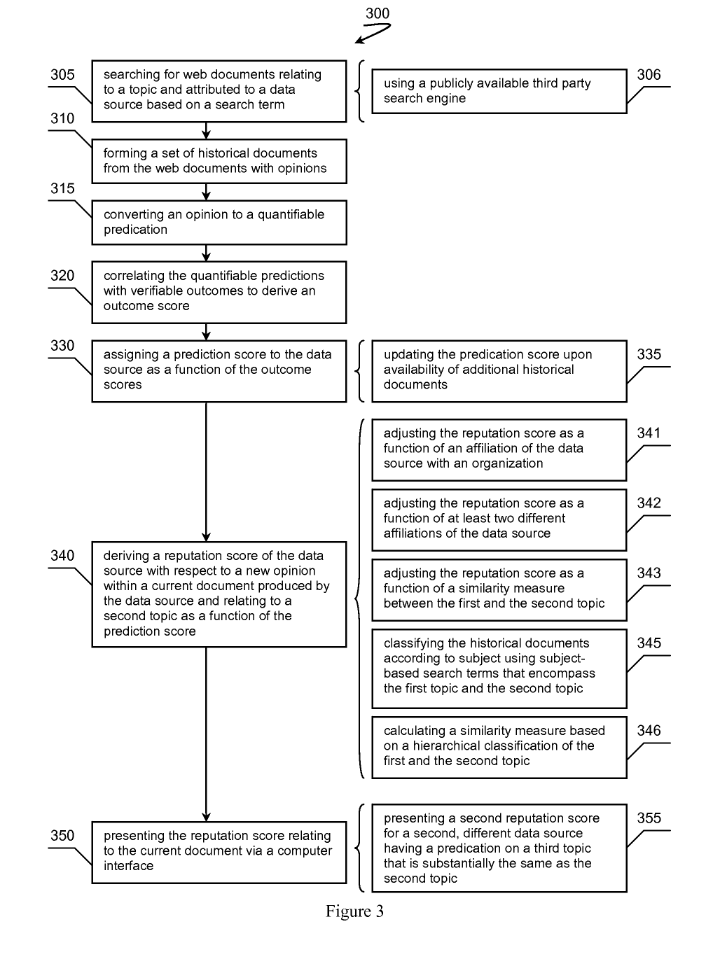

In FIG. 3, method 300 outlines a more detailed approach for quantifying a data source's reputation with respect to a topic. In a preferred embodiment, method 300 or variants of method 300 are conducted with the aid of a computer system comprising one or more computers storing software instructions used to convert historical data into a reputation score that can presented via a computer interface.

At step 305, in a preferred embodiment, a computer system is used to search for web documents relating to one or more topics and attributed to a data source. In some embodiments, at step 315 the topic can be represented by a search term submitted to a search engine (e.g., Google, Yahoo!, MSN, etc.), which in turn then searches for documents having the term at step 306. A search term, as previously discussed, can include a key work, image data, audio data, or other forms of digital data that can preferably be used by a computer to automatically identify web documents of interest. One can identify the web documents by matching search terms with content data within the document or by matching search terms within metadata describing the document (e.g., author, owner, time stamps, tags, etc.). Web documents can also be identified by crawling through web documents searching for the topic or data source looking for direct matches or indirect matches to search terms. Indirect matches can be found using techniques that relate one topic to another similar to those described in co-owned U.S. patent application having Ser. No. 12/253,567, titled “Systems And Method Of Deriving A Sentiment Relating To A Brand”; or co-owned U.S. patent application having Ser. No. 12/265,107 titled “Methods for Identifying Documents Relating to a Market”.

At step 310 a set of historical documents is formed from the web documents found while searching at step 305. The documents within the set preferably satisfy search terms used to search for the web documents and preferably include an opinion expressed by the data source. One should note that the set of historical documents can collectively or individually relate to more than one topic.

At step 315 opinions expressed by the data source are converted into one or more quantifiable predications. The predications can be directly quantifiable due to a reference to a numerical value, a rating for example as previously discussed. The predication could also be indirectly quantifiable where no numerical value is expressly stated. Rather the predication can be quantified by converting subjective content within the historical documents to a numerical value. In some scenarios, the indirect predications are of an absolute nature where the data source makes a statement with respect to the topic. For example, a computer model could make an absolute predication by recommending a “buy” rating for a stock. In other scenarios, indirect predications can be relative in nature where a data source compares a topic with another topic. For example, a reviewer could state that movie “A” is better than movie “B”. Regardless of the form of an indirect predication, the predications can be converted to numerical values. In the examples just presented, the predications can be quantified by assigning a Boolean value, or more preferably, a numerical value, possibly a “1”, “0”, or “−1”. The quantified predications allows for direct comparison against a verifiable outcome. All methods of quantifying indirect predications are contemplated.

It is also contemplated that subjective opinions can be converted to a quantifiable predication based on analysis of the terms used with respect to a cited topic. Web documents that pertain to a topic domain other than those attributed to a data source can be analyzed to determine correlations among combinations of terms found in the document used to express ideas with respect to the topic. The correlated term combinations could be used to determine if subjective terms have a correlation to values. For example, web documents relating to video games could reference the word “phat” to indicate a video game is considered highly rated. An analysis engine could correlate the use of the term “phat” with ratings expressed in the same documents or other documents associated with the topic domain. The result is that “phat” could be equated to a value. If an opinion attributed to a data source uses the word “phat”, then the opinion can then be converted, albeit indirectly, to a quantifiable predication have a value that corresponds to “phat” as derived from analysis of the topic domain space.

In a preferred embodiment topics are classified as belonging to various classifications. Contemplated classifications schemes include forming a hierarchical taxonomy of topics where subject matter is arranged by domains and where each domain has one or more levels of categories. Some embodiments employ hierarchical classifications schemes where the domains are defined by a third party (e.g., an entity other than the entity offering access to the disclosed techniques). For example, topics could be arranged based on Yahoo!'s subject areas, based on Amazon's product offerings, based on tag clouds offered by Digg.com, or based on other third parties. Furthermore, a topic could be a category within the third party's classification scheme. Consider, for example, the domain topic of movies. Amazon offers a product domain of “Movies & TV” where the domain is broken down by categories based on “Genre” including classics, drama, comedy, kids, sci-fi, etc. One should note that historical documents can be classified as belonging to one or more domains or categories. Other classification schemes can be based on meta-tags assigned to documents, latent semantic analysis of documents, or even based on subjective review by humans. Topic classification provides for determining a similarity measure of one topic to another as discussed below.

Data sources represent an entity responsible for the content of the historical documents. In a preferred embodiment, a data source includes a person or an organization possibly a business or a group. A person or a group could be affiliated with an organization possibly being employees of the organization, for example. It is also contemplated that a data source could include a computer system operating as a model or simulation. For example, a computer system could be used to analyze the stock market to determine if one should buy or sell stocks. In which case, the data source could be the computer model.

The historical documents are preferably attributed to a data source. As with topics, a document can be identified as originating from one or more data sources using search terms to search for web documents that relate to the data source. The search terms corresponding to the data source can be used to represent an author, a company, a brand, a patent, an address, or other identifying characteristics that could be used to determine if a document originates from a data source.

The historical documents preferably include a discernable time frame within which a predication is expected to come be complete or when the predication can be verified. Preferred time frames are explicitly stated within the documents. For example, a computer model could state that a stock has a buy rating for the next ten days. The predication would be that the stock price will be higher at the end of ten days. Other time frames can be inferred, or simply defined. An inferred time frame represents a time frame that is not stated within the document but rather relates to other aspects of a given topic external to the document. For example, a reviewer could rate a movie based on a preview where the release date has yet to occur. The reviewer's rating represents a predication of how well the public will receive the movie and the release date represents the time frame when the predication can be verified. In other cases, one can simply define a time frame. For example, similar to a movie reviewer, an early adopter for a consumer electronic product could offer his opinion regarding the product in the form of a rating. The computer system operating method 300 could be programmed to observe public response to the product for a set time frame before determining the outcome of the predication. The time frame could be measured in time (e.g., within one month, one quarter, or after a year), or could be based on the number of products sold no matter the time (e.g., after the sale of 10,000 units).

It is contemplated that as the disclosed techniques become mainstreamed, standardized time frame metrics can be established for various predictions. For examples, with respect to movies, time frames could include the first weekend of release, the first month after release, the first six months after release, or based on the number of views to allow for aggregation of statistics. Product review time frames could also be established and could include quarterly updates to reviews. Such an approach allows product reviewers or early adopters to review a product, then allow the general masses to build statistics that become a verifiable outcome

The set of historical documents identified within step 310 is considered to be a dynamic set. The set of documents can be changed as time passes for various reasons. In some cases, documents are added to the set as new verifiable outcomes can be brought to bear against new documents having newly expressed, yet unverified, opinions. Additionally, documents in the set can be culled as time passes to remove documents that are no longer relevant, or become stale. As the set of documents changes through additions, removals, weightings, or other modifications, a resulting reputation score could also change as a function of time.

At step 320 at least some of the quantifiable predications from the historical documents are correlated with verifiable outcomes to derive an outcome score that represent a measure of how accurate the opinion was. Preferred verifiable outcomes include a direct reference within a web document to a quantifiable value that can be compared to the predications. Other verifiable outcomes can comprise an outcome that can be indirectly quantified in a similar fashion as previously described for predications.

In a preferred embodiment, verifiable outcomes comprise documents that can be used to verify a predication. The outcome documents can include web documents that can be identified through searching possibly including searching through blogs, forums, e-commerce sites, or other web documents. Outcome documents can include text, images, audio, or other information that can be used to compare against a predication.

The type document corresponding to verifiable outcome often correlate to a topic of interest. For examples, a verifiable outcome for a product review can include consumer ratings set on an e-commerce site or community site (e.g., ratings for product on Amazon, game ratings on a GameSpy.com, etc.). Additionally, verifiable outcomes for stocks could include a simple stock listing in a newspaper or one a web site found at a later date than the predication. One should note that there can be more than one verifiable outcome per predication, each of which can be used to aggregate statistics. For example with respect to video game reviews, one could use GameSpy™, GameZone™, GameSpot™, or GameRankings.com™ to obtain outcome documents where aggregated player ratings from each site can be used to verify a single reviewer's original opinion.

In a preferred embodiment, the outcome scores are derived from quantifiable predications having a verifiable outcome. An outcome score could be derives by simply subtracting a quantified value for the predication (P) from the quantified value for the outcome (O). Preferably, all outcome scores (OS) are normalized to a common scale to allow aggregation of statistics. For example, all outcomes scores (OS=O−P) could be normalized to a scale running from −10 to 10 where predications and outcomes have been normalized to a scale of 0 to 10. A negative value could indicate that data source tends to generate opinions that a higher than reality a positive value could indicate that a data source generates opinions lower than actual outcomes. A value of zero would indicate that the data source was accurate, at least accurate on average.

Normalizing outcome scores provides for aggregating many predications on equal footing to build statistics with respect to the data source's accuracy in rendering opinions that match reality. In some embodiments each opinion, predication, or their correlated verified outcome can be stored in a database for later analysis, or for use in deriving a reputation score for the data source. Furthermore, each predication and outcome entry in the database can be indexed with respect to topic of the corresponding opinion. Such a database provides for recalculation of a reputation score, as desired, as a data source generates opinion documents directed to different topics. For example, some outcome scores can be under weighted when calculating a reputation score if the topics associated with the outcome scores lack sufficient similarity to a topic of interest. Outcome scores can be weighted for various reasons including topic similarity, age of predication, expertise of the data source with respect to a topic, affiliations of the data source, or other reasons.

At step 330 a prediction score is assigned to the data source as a function of the aggregated outcome scores. The predication score could be a simple average of all the outcome scores with respect to topic, or a weighted average of the outcome scores. The predication score could be a single-value representing the accuracy of all of a data source's predications, or the predication score could be multi-valued. A multi-valued predication score can include values associated with each of the various topics possibly broken down by domain, or category within a domain. For example, movie reviewer could have a single predication score representing the reviewer's accuracy with respect to all movies. Additionally, the reviewer's predication score could have a value for each genre of movie that the reviewer has opined.

In a preferred embodiment a predication score is an aggregation of many outcome scores. An astute reader will recognize that the predication score could be characterized by a statistical distribution having a characteristic width. For example, a predication score could be represented by a Gaussian, Poisson, or other distribution. The width associated with a predication score also provides insight into the accuracy of a data source where the width indicates a precision of the data source's opinions. If the width is large, the data source lacks precision even if the predication score indicates the data source is accurate on average. If the width is narrow, the data source would be considered precise, or at least consistent, even if the predication score indicates the data source lacks accuracy.

In a preferred embodiment, predication scores are treated as dynamic values that can change with time. At step 335 a predication score can be updated based upon availability of additional historical documents or verifiable outcomes. Inclusion or exclusion of historical documents can cause a predication score to improve or worsen as a result of the functions used to calculate the predication score with respect to outcome scores, or depending on the nature of the historical documents. In preferred embodiment, the predication score can be updated automatically based on one or more rules, possibly based on document dates, topics, consumer feedback, etc. The rules can be used to govern which predications or outcomes in a database should be used to calculate a predication scores.

At step 340 a reputation score is derived for the data source, preferably as a function of the predication score. In a preferred embodiment the reputation score is derived with respect to a new predication within a current document (e.g., a document that has no verifiable outcome) produced by the data source. The current document can be directed toward the same topic, a similar topic as the historical documents, or could be a completely different topic.

The reputation score could be simply equal to the predication score calculated in step 330. In more preferred embodiments the reputation score is calculated or adjusted based on multiple parameters relating to the data source, the documents, topics in both historical and current documents, credentials of a data source (e.g., a certification, a college degree, number of citations of peer reviewed articles, etc.), outcome scores, or other available information as described below.

At step 341 the reputation score can be adjusted as a function of an affiliation of the data source with an organization. In some scenarios historical documents attributed to the data source are limited in number or simply do not yet exist. The historical documents used for analysis can be indirectly attributed to the source, possibly through an affiliation. For example, the historical documents could originate from the source's employer. In such a case, the reputation score of the data source can be calculated by weighting outcome scores or predication scores of a predication stemming from the organization. The reputation score of the source could be increased when the organization has a solid reputation, or the reputation score could be decreased when the affiliation is less strong.

At step 342 the reputation score can be adjusted as a function of at least two different affiliations of the data source. For example, data source could be an employee of a reputable business and could also be a graduate of a prestigious university. Both affiliations could be used strengthen or weaken the reputation score by appropriately weighting the outcome scores or predication scores. In a preferred embodiment, the weighting of affiliations is based on the topics of the historical documents or the topic of the current document made available by the source. Weighting by topics provides for fine grained view of a reputation of a data source.

The reputation score can also be adjusted based on the similarity of the topics in the historical documents to the topic of the data source's current document. In some embodiments, at step 343, the reputation scored is adjusted as a function of a similarity measure between the two topics. A similarity measure can be calculated by determining a correlation between a first piece of digital data representing a first topic and a second piece of digital data representing a second topic. Such an approach is described in co-owned U.S. patent application having Ser. No. 12/265,107 titled “Methods for Identifying Documents Relating to a Market” where correlations between terms are automatically derived. The number of inferred links between terms can be used as a similarity measure, which in turn can be used to weight outcome scores or predications score composing a reputation score. For example, the topic “Movie” could be found to be linked to the following term chain: movie video DVD recording. The similarity measure of the topics “movie” and “a recording” could have a value three to represent the number of links between the topics. Contemplated similarity measures can also be derived from associations of attributes assigned to each of the document with respect to topics (e.g., same attributes, number of common attributes, etc.), from number of citations by others with respect to topics, or from other forms of identifying relationships among topics. One example could include using patent technological classes to derive a similarity measure.

It is also contemplated at step 345 that historical documents could be classified according to subject matter using subject-based search terms that encompasses the topics of the documents, historical or current. For example, the historical documents could be pre-indexed based on subject using any suitable classification scheme, including a hierarchical scheme. The classification scheme could then be used to calculate a similarity measure, possibly based on the number of levels in a hierarchy separating the topics as suggested by step 346.

As with a predication score, a reputation score can be single-valued or multi-valued. In a preferred embodiment, the reputation score can have values with respect multiple topics where the reputation score has a first value for a first topic and a second value for a second topic. For example, the reputation of the reviewer can be represented by a score for movies in general and by a score for a movie genre, or scores for multiple genres. Additionally, a reputation score can include a width in embodiments where the reputation score is derived from a predication score having a distribution. The width of the reputation score preferably corresponds to a measure of precision of a data source's opinions with respect to a topic.

Similar to predication scores, a reputation score is also considered dynamic and capable of changing with time or conditions. As historical documents come or go, the reputation score for a data source or a current document could change. In some embodiments, the reputation score is periodically updated (e.g., hourly, daily, weekly, monthly, quarterly, etc.) to reflect aggregation of statistics. It is specifically contemplated that newly added historical documents could include a data source's current document once the current document's new predication has been verified. Once added, the various scores including the predication or reputations scores can be updated. In a preferred embodiment, the system updates scores automatically without requiring a user to request an update.

A reputation scores can be calculated on a document-by-document basis. An analysis engine can analyze a current document to determine the topic or topics of the document. Then the topic information can be used to query a database storing references to historical documents or outcome documents relating to the topics. The result set from the query can then be used to derive the necessary outcome scores, predication scores, or reputation scores, along with any appropriate weighting.

At step 350 the reputation score relating to a current document of the data source is presented to a user via a computer interface. In some embodiments, the current document is presented along with the reputation score, possibly within a result set returned by a search engine. It is also contemplated that document attributed to the data source could be ranked according one or more values of the reputation scores including a width indicating a data source's precision. For example, an individual could submit a query directed toward the data source to a search engine. The search engine can return many documents, current or historical, where the returned comments can be presented ranked according to reputation scores, predication scores, or even outcome scores. Furthermore the individual could submit a query directed to a topic, in which case documents from different data sources can be presented at the same time. At step 355 a second reputation score is presented for a second data source that also has predications stemming from opinions on a topic similar to or the same as that of the original data source. Such an approach allows a user to compare or contrast the accuracy of the different data sources with respect to topics.

Presenting of the reputations scores and/or current documents via a computer interface can be performed using any suitable means. In a preferred embodiment, the computer interface comprises an application program interface (API) that allows a software application to access other software applications or modules to search for or obtain the reputation scores. For example, the API can be implemented to access a database storing historical data relating to the predications. Preferably the API is integrates into an analysis engine, possibly a marketing analytics engine, as discussed previously. It is also contemplated that the computer interface can include a web services program interface to allow remote users to access on-line services offering access to the disclosed techniques.

Reputation scores can also be presented graphically. In some embodiments a data source's reputation score can be presented as a tag cloud where each tag represents a topic and its size could represent the value of the score or represent a precision (e.g., width) of the score. It is also contemplated that reputation scores could be presented as an interconnected semantic graph where the nodes of the graph represent topics. For example, if an individual searches for documents attributed to a data source, the graph can be presented where a central node could be used to represent the topic of the documents currently in view. As the individuals browses the documents, the graph can rotate to focus on a different node that more closely rates to the topics of the documents that are currently being viewed. Reputations scores, or other scores, can also be presented graphically as a function of time to illustrate the historical track record of a data source, possibly to indicate how the source has improved.

The disclosed techniques are presented in view of a single data source. However, it should be noted that a data source could, in fact, be a group or an organization. In such a scenario, the historical documents expressing the opinions of many people affiliated with a group can be aggregated together to essentially consolidate their opinions as a single opinion which is reinforced by a reputation score.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of quantifying a reputation of a data source with respect to a topic, the method comprising:
searching for web documents relating to a first topic and attributed to a data source based on a search term;
forming a set of historical documents from the web documents satisfying the search term where each of the historical documents includes an opinion of the data source with respect to the topic;
converting each opinion automatically into a quantifiable predication;
correlating at least some of the quantifiable predictions with verifiable outcomes to derive an outcome score for each of the at least some of the predications;
assigning a prediction score to the data source as a function of the outcome scores;
deriving a reputation score of the data source with respect to a new opinion within a current document from the data source and relating to a second topic as a function of the prediction score; and
presenting the reputation score relating to the current document to a user via a computer interface.

2. The method of claim 1, wherein the step of searching for web documents includes using a publicly available third party search engine.

3. The method of claim 1, wherein the step of deriving the reputation score includes adjusting the reputation score as a function of an affiliation of the data source with an organization.

4. The method of claim 3, wherein the data source is an employee of the organization.

5. The method of claim 3, further comprising adjusting the reputation score as a function of at least two different affiliations of the data source.

6. The method of claim 1, wherein the second topic is different than the first topic.

7. The method of claim 6, wherein the step of deriving the reputation score includes adjusting the reputation score as a function of a similarity measure between the first and the second topic.

8. The method of claim 6, further comprising classifying the historical documents according to subject using subject-based search terms that encompass the first topic and the second topic.

9. The method of claim 8, further comprising calculating the similarity measure based on a hierarchical classification of the first and the second topic.

10. The method of claim 1, wherein the data source comprises a business.

11. The method of claim 1, wherein the data source comprises a person.

12. The method of claim 1, wherein the data source comprises a computer model.

13. The method of claim 1, further comprising updating the predication score upon availability of additional historical documents.

14. The method of claim 13, wherein the additional historical documents include the current document after the new predication has been verified.

15. The method of claim 1, wherein the step of presenting the reputation score along with the current document includes presenting a second reputation score for a second, different data source having a predication on a third topic that is substantially the same as the second topic.

16. The method of claim 1, wherein the quantifiable prediction comprises a discernable time frame.

17. The method of claim 1, wherein the computer interface comprises a web service application program interface.

18. The method of claim 1, wherein the first topic comprises a domain defined by a third party's classification scheme.

19. The method of claim 18, wherein the second topic comprises a category within the domain.

20. The method of claim 1, wherein the reputation score comprises multiple values.

21. The method of claim 20, wherein the reputation score includes a measure of precision.

22. The method of claim 20, wherein the reputation score includes a first value for the first topic and a second value for the second topic.
